(19) United States
(12) Patent Application Publication
(10) Pub. No.: US 2008/0137808 A1
(43) Pub. Date: Jun. 12, 2008

(54) Density Measuring Apparatus

(76) Inventors: Kenneth James, Cleveland (GB); Peter Jackson, Cleveland (GB)

Correspondence Address: JONES DAY, 222 EAST 41ST ST, NEW YORK, NY, 10017, US

(21) Appl. No.: 11/793,397

(22) PCT Filed: Dec. 19, 2005
(86) PCT No.: PCT/GB2005/050253

§ 371 Date: Jun. 19, 2007

(30) Foreign Application Priority Data
Dec. 23, 2004 (GB) 0428193.7

(51) Int. Cl. G01N 23/06

(52) U.S. Cl. 378/53

(57) ABSTRACT

An apparatus for measuring the bulk density of a fluid within a vessel comprises a radiation source and detector and at least one titanium dip tube penetrating the wall of the vessel to provide a path for radiation from the source to the detector through the vessel via the dip tube. The apparatus facilitates the use of a low energy radiation source for measuring the density of e.g. a gas stream in a thick-walled pressure-resistant vessel.

The present invention relates to apparatus for measuring the bulk density of a fluid and in particular for monitoring changes in the bulk density of a fluid, particularly when the fluid is under pressure.

In gas and oil production it is often necessary to separate aqueous, oil and gas phases that form the flow from a production well. Water and gas are often naturally co-produced with oil and, as oilfields approach the end of their useful life, water is often injected into the oil bearing strata to maintain the production of oil and this results in the stream from the production wells including an increasing proportion of water.

Typically such separation is carried out in a separation system which may include pre-separation means such as a cyclone or flow-splitter to separate much of any gaseous phase present from the liquid phases. In order that as much of the liquid phase may be removed from the gas as possible, the operation of the separator may be controlled by monitoring the amount of liquid in the separated gas stream and then adjusting the operating conditions of the separator so that more or less liquid is allowed to flow with the gas stream. The adjustment of the separator may be by means of a manual system or an automated feedback circuit.

In order to operate the system it is necessary to determine the amount of liquid contained in the gas stream. The gas stream is usually under very high pressure. In order to withstand such pressure the pipelines and associated equipment are highly specified for safety reasons. For example, the pipelines generally must be of 25 mm thick steel.

When a gas contains a liquid phase, its bulk density is higher than the bulk density of the gas in the absence of liquid. Therefore it is convenient to monitor changes in the amount of liquid entrained in a gas stream by measuring its bulk density continuously or periodically over time. The use of radiation to measure the density of the contents of a vessel is well-known. For example WO00/22387 describes a density profiler for measuring a density profile of a medium including at least two liquid and gaseous phases includes an axially distributed source array providing at least 10 collimated ionising radiation beams; an axially distributed radiation detector array, each detector associated in use with one of the beams and producing an output signal in response to incident radiation; and an analyser for the detector output signals to determine the density of the medium traversed by the beams of radiation. The density profiler is designed for insertion into a vessel and is not suitable for the measurement of the liquid entrained in a gas stream in the extremely high pressure environment existing upstream of the separator vessel.

It is an object of the invention to provide an alternative apparatus for the measurement of the bulk density of a fluid within a pipeline or vessel.

According to the invention we provide an apparatus for the measurement of the bulk density of a fluid within a vessel comprising a source of radiation located outside the vessel, collimation means to direct the radiation through at least a portion of the vessel, a detector for detecting the radiation, said detector being located outside the vessel and arranged with respect to the radiation source such that it is capable of detecting radiation from said source after it has passed through a portion of the vessel, and at least one dip tube aligned with said radiation source in such a way that radiation from the source may enter the vessel through the dip tube.

According to a second aspect of the invention, we provide a method of measuring the bulk density of a fluid within a vessel comprising directing radiation from a radiation source through a portion of a vessel containing the fluid towards a radiation detector and calculating the bulk density of the fluid or a change in the bulk density of the fluid using information about the amount of radiation detected by the detector, characterised in that the radiation source and radiation detector are each located outside the vessel and that the radiation is directed into the vessel via a dip tube penetrating the wall of the vessel.

When we refer to a “vessel” we include closed and open vessels such as containers, reactors etc and also pipelines and other transport vessels. The apparatus facilitates the use of a low energy radiation source for measuring the density of e.g. a gas stream in a thick-walled pressure-resistant vessel. The use of a low energy source is beneficial in increasing the sensitivity of the apparatus to changes in the bulk density of the fluid medium in the vessel.

The energy of the source radiation is typically not more than about 750 keV and is desirably lower than this. The source can be a radioactive isotope as is used in conventional (single source/detector) density gauges where the radiation source is commonly the 661 keV gamma radiation from ¹³⁷Cs. The use of a lower energy source is, however, desirable and energies of less than 500 keV, particularly less than 300 keV and optimally less than 100 keV, are desirable in this invention. This is because when a change in bulk density is to be measured, the change in the radiation detected by the detector is proportionately larger for a low energy source than for a higher energy source and so the measurement of change is more sensitive. The minimum energy of the radiation is about 20 keV; less energetic radiation will generally have too short an effective path length to be useful, and more desirably the source energy is at least about 30 keV, ideally from about 30 to about 60 keV. Thus, lower energy sources than ¹³⁷Cs gamma sources are desirable. Potential sources include ¹³³Ba which is a 356, 80, 36 and 30 keV gamma source, ²¹⁰Pb which emits gamma at 47 keV and ²⁴¹Am which is a 60 keV gamma source.

For a permanent installation, a radioisotope source will be chosen to have a relatively long half life both to give the equipment a satisfactory service life and to reduce the need to recalibrate to take account of reduction in source intensity from source ageing. Usually, the half life of the radioisotope used will be at least 2, and desirably at least 10, years, and not usually more than about 10000, more desirably not more than about 1000, years. The half lives of the radioisotopes mentioned above are: ¹³⁷Cs gamma ca. 30 years, ¹³³Ba ca. 10 years, ²¹⁰Pb about 22 years and ²⁴¹Am ca. 430 years. These values, especially for the Americium, are satisfactory for use in the measurement apparatus and method of the invention. Other radioisotope sources can be used if desired, especially those having properties as described above, but other such sources are not generally readily available from commercial sources. By using low energy sources, equipment handling and source shielding are also made safer and/or easier. The source radiation could also be X-rays and, although robust compact sources are not easy to engineer, for such sources intrinsic source half life is not a problem.

Desirably the source activity will be at least about 4×10⁷ more usually from 4×10⁸ to about 5×10¹⁰, Becquerel (Bq). The use of sources with lower activity may require unduly long integration times to obtain adequately precise results (signal to noise ratio) and more active sources are relatively expensive and/or may lead to swamping of the detectors. ²⁴¹Am sources having an activity of about 1.7×10⁹ Bq are readily commercially available and are suitable for use in this invention. A typical source is supplied in the form of a 15 mm diameter disk, e.g. of ²⁴¹Am in a suitably shielded package.

The type of detector used in the apparatus and method is not critical although in practice a compact device will usually be chosen. The detector may be electrically powered e.g. a Geiger-Muller (GM) tube or scintillation detector linked with a photomultiplier, or un-powered as in simple scintillation devices. Among electrically powered detectors, GM tubes are particularly convenient, because they are electrically and thermally robust and are available in mechanically robust forms. Among un-powered detectors scintillation detectors linked to counters by fibre optic links (optionally with photomultipliers outside the container for the medium under test) are particularly useful. When electrically powered detectors are used and especially when the density gauge is used in a combustion or explosion risk environment, it is desirable that the total electrical energy and power associated with the detectors is sufficiently low as not to be a significant source of ignition in the event of system failure (particularly resulting in direct contact between combustible or explosive materials and any electrically live components). Photomultipliers generally require relatively large amounts of electrical power (as compared with GM tubes) and it is thus preferable to avoid including these (effectively) as part of the detector. GM tubes are readily available with physical dimensions of cylinders about 12.5 mm long and about 5 mm in diameter. Un-powered scintillation detectors with fibre optic links are preferred for use in a gas production field because there are no electrical components necessary so the operation is intrinsically safer. For use in a gas production environment an explosion-proof scintillation counter fitted with a plastic window, such as a PRI 116, is suitable.

The counting devices for any of these detectors will usually be electronic and the detector is associated with a counter which may be linked to a data handling device that translates the detection (count) rate to a measure corresponding to bulk density of the fluid within the vessel. The apparatus may therefore further comprise a data handling means for receiving information from the radiation detector and providing information concerning the bulk density of the fluid within the vessel. The data handling means may be programmed to convert the detector output to bulk density data using pre-determined values to relate the proportion of radiation from the source detected by the detector to the bulk density of the fluid using the specified source and detector. As will be readily understood, the amount of radiation from the source which penetrates the vessel and fluid contained within the vessel depends upon the mass of the fluid and its ability to absorb radiation. Thus an increase in the bulk density of the fluid flowing or contained within the vessel leads to a reduction in the amount of radiation which reaches the detector as more radiation is absorbed by the fluid.

The output from the detector may be monitored continuously or intermittently depending upon the particular application.

At least one dip tube is provided which penetrates the vessel at the location at which the measurement is intended to be made. The dip tube is aligned with the radiation source in such a way that radiation from the source may enter the vessel through the dip tube whilst the radiation source itself remains outside the vessel. As a preferred embodiment, the radiation leaving the vessel which impinges on the detector travels along the path of a second dip tube which is aligned with the detector. The dip tube is generally cylindrical and has a closed end which, in use, faces the interior of the vessel. Preferably the closed end of the dip tube has a domed or hemispherical shape, the dome may have more than one radius of curvature. The dip tube, when located in the wall or walls of the vessel may extend beyond the interior wall of the vessel. When inserted into a high pressure pipeline, the end of the dip tube preferably does not extend more than 10 mm, more preferably 5 mm, into the pipeline beyond the interior surface of the pipeline wall, and most preferably it is substantially flush with the interior wall of the vessel.

The material of the dip tubes is chosen to have sufficient strength and chemical resistance and to be suitably transparent to the ionising radiation. Using high energy sources, transparency is not likely to be a problem (and consequently proper safety shielding may be a problem) and materials such as stainless steel can readily be used. Using low energy sources e.g. ²⁴¹Am, the dip tube(s) are preferably made of titanium or an alloy thereof, at a thickness of from 1 to 4 mm, or high performance synthetic composites e.g. fibre (glass or carbon) reinforced PEEK (aromatic poly-ether-ether-ketone) where the wall thickness may be higher e.g. from about 3 to about 10 mm. The wall thickness of the dip tube may vary in order to provide the maximum strength and resistance to pressure commensurate with offering a path for radiation to penetrate the end of the dip tube and enter the vessel. Normally the thinnest part of the dip tube is located at the closed end in the path of the radiation. Thus the minimum thickness of the dip tube is, in part, dictated by the ability of radiation from the source to penetrate the closed end of the dip tube and enter or exit the vessel. For use in a gas production facility, the dip tube is made of titanium, most preferably grade 5 titanium, in order to meet international safety codes. When the vessel is a pipeline designed to withstand high pressure of up to about 250 bar then the minimum thickness of the dip tube is preferably 3 mm of titanium. The dip tube is shaped to be able to withstand high pressure when fixed within the walls of the vessel.

When an electrically powered detector is used and the material of the dip tube is metallic a separate electrically insulating barrier will generally also be provided.

A typical application of the apparatus and method is the measurement of and detection of change in the bulk density of natural gas within a pipeline at or near downstream of a production well. The measurement is made in order to detect the amount of liquid carried in the gas stream and more particularly to detect a change in the amount of liquid within the gas stream. Normally this measurement is required to monitor and control the operation of apparatus such as a flow splitter or cyclone which separates the gas from liquid, usually located upstream of the apparatus of the invention. The amount of liquid carried over in the gas stream may be monitored using the apparatus and method of the invention and thus the apparatus in this application may be termed a “carry-over gauge” or “entrainment meter”. The amount of radiation detected by the detector is proportional to the bulk density of the fluid in the pipeline and thus a change in the radiation detected may indicate that too much liquid is being carried over from the flow-splitter or that the liquid content is within specification so that the flow-splitter may be adjusted if necessary. The control system for the flow-splitter may be programmed to respond directly to the measurement of radiation detected. Alternatively the data handling means may calculate the bulk density of the fluid and this derived information may be passed to a control system. In this application, the detector is monitored intermittently at an interval of between 1 and 10 seconds.

An embodiment of the apparatus according to the invention will be further described, by way of example and with reference to the accompanying drawings, which are: —

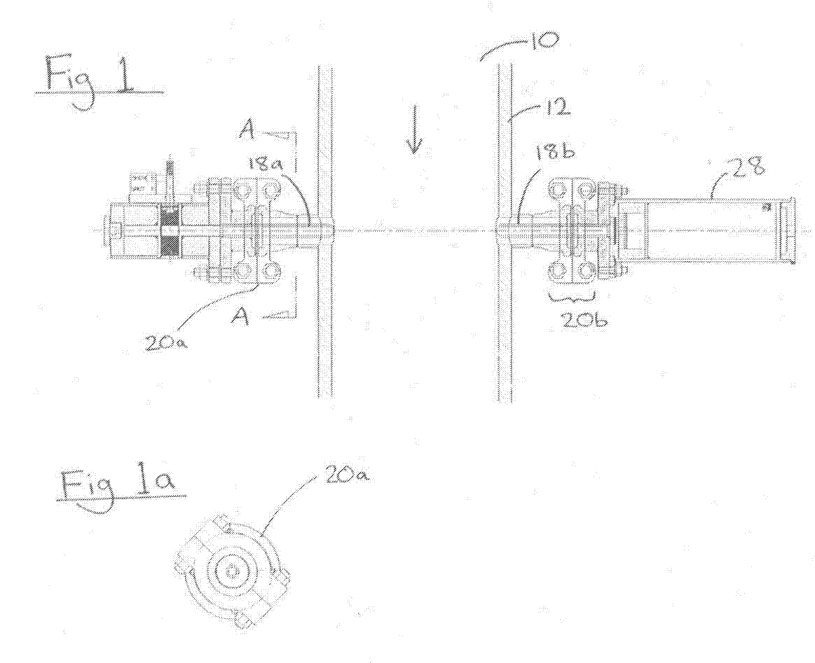

FIG. 1: a section through a pipeline in which an apparatus according to the invention is fitted

FIG. 1a: a section through a portion of the apparatus showing the dip tube.

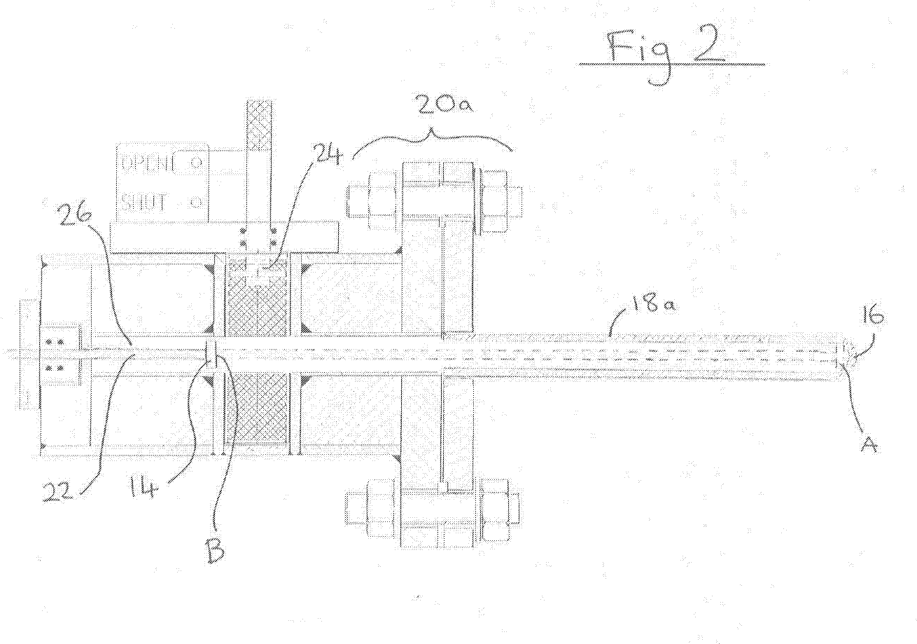

FIG. 2: a sectional detail showing the dip tube with the source in working and closed positions.

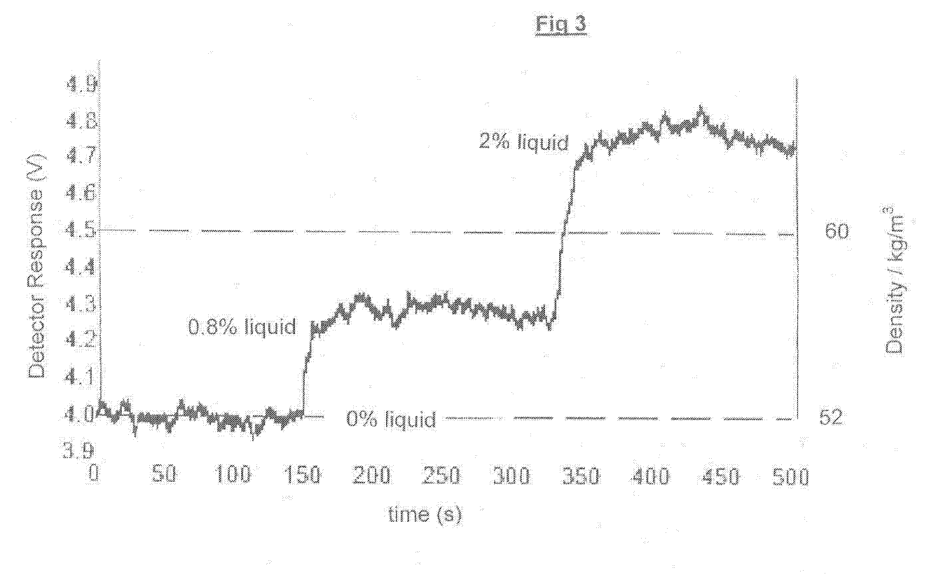

FIG. 3: a plot of detector response (V) over time (s) using the apparatus of the invention.

In FIGS. 1 and 2 we show a section through a pipeline 10, adapted to contain high pressure gas flowing in the direction of the arrow, and having a wall 12 of approximate thickness 25 mm. The apparatus for measuring bulk density comprises a radiation source 14, which in operation, is located adjacent the closed end 16 of dip tube 18a. The dip tube is made of titanium and has a hemispherical closed end which is held in place flush with the inner surface of the pipe wall 12 by means of a commercially available Techlok™ clamping system shown generally as reference 20a. The clamping system is also shown in FIG. 1a. Referring to FIG. 2, the source 14 is supported on a rod 22 by which the source may be moved towards and away from the closed end of the dip tube. The source may be deployed in position A (shown by dotted lines) or may be withdrawn to position B. the deployment mechanism has been omitted from the drawing but may be of any suitable mechanical means e.g. a screw thread or piston. When in position B, the source may be isolated by means of a shutter 24 within chamber 26. The detector 28 is located in alignment with a dip tube 18b, held in place by means of a second Techlok system. The detector is a scintillation counter of type PRI 116 (available from Johnson Matthey, Tracerco).

In use, the source is deployed adjacent the end of the interior bore of the dip tube 18a and radiation may penetrate the closed end of the dip tube 18a, traverse the fluid and pipeline and penetrate the dip tube 18b to be detected by detector 28. The detector monitors the radiation penetrating the fluid and thus changes in the magnitude of radiation detected indicate a change in the bulk density of the fluid in the pipe. The bulk density may then be directly related to the amount of liquid entrained in a high pressure gas flowing through the pipe 10. The detector output is used by a control system which is capable of adjusting the entrained liquid to the desired level.

### EXAMPLE 1

In an experiment two titanium dip tubes, each being closed at one end, the closed end having a hemispherical profile, and each having a minimum wall thickness of 3 mm were set apart with their longitudinal axes aligned and with their blind ends facing each other. An ²⁴¹Am source was inserted into one dip tube and a scintillation counter was arranged to detect radiation within the second dip tube. A sheet of polyethylene of 20 mm thickness was placed between the two dip tubes to simulate the presence of a dense gas phase. Then successive sheets of polyethylene of thickness proportional to the increase in bulk density caused by 0.8% and 2% of liquid entrained in the gas were placed between the dip tubes cumulatively with the 20 mm sheet. The detector response over time is shown in FIG. 3. This example shows that the use of the apparatus of the invention allows sensitive measurement and detection of small differences in the bulk density of a fluid within a vessel. The skilled person will appreciate that suitable safety procedures must be rigorously followed when handling gamma sources such as the one used in this experiment.

### EXAMPLE 2

A steel pipe (14″ NB Schedule 100 (355 mm OD)) was fitted with an apparatus similar to that shown in FIGS. 1 & 2. The titanium dip tubes extended through the wall of the pipe and were placed in Weldolet fittings welded to the pipe, and clamped on with Techlok™ clamps as shown in FIG. 1. The source used was a 60 keV gamma source (²⁴¹Am). The apparatus was tested by inserting polyethylene sheets into the pipe between the source and detector to simulate a fluid of different bulk densities within the pipe. The polyethylene sheets were of thicknesses of 3 mm (dry gas, 10.05 kg/m³), 11 mm (wet gas, 34.18 kg/m³, equivalent to a liquid content of 2.5% at 12 bar) and 18 mm (equivalent bulk density of 55 kg/m³ equivalent to a liquid content of 5% at 12 bar).

TABLE 1

| Polyethylene | Measured count | Calculated bulk |
|---|---|---|
| thickness (mm) | rate (counts/s) | density (kg/m³) |
| none | 7688 | 1 |
| 3 | 7285 | 11.1 |
| 11 | 6283 | 33.16 |
| 18 | 5532 | 56.72 |

### EXAMPLE 3

The apparatus described in Example 2 was pressure-tested and then installed in a well-fluid stream at the gas outlet of a phase splitter, itself installed downstream of a manifold. The density of the gas phase was varied by adjusting the outlet valve of the liquid outlet of the phase splitter, causing an increase or decrease in the pressure in the manifold and thus a change in the amount of liquid entrained in the gas flow from the gas outlet. Such a change in flow changes both the liquid fraction and the gas density in the gas flow. The density of flow in the pipeline was monitored using the installed source and detector apparatus and the results are shown in Table 2.

TABLE 2

| Manifold | Measured |
|---|---|
| Pressure | density |
| (bar) | (kg/m³) |
| 14.4 | 15.3 |
| 15.2 | 17.6 |
| 16.1 | 20.5 |
| 14.9 | 15.9 |
| 14.4 | 14.3 |

The results show that the apparatus may be used to monitor changes in the bulk density of a fluid flowing in a steel pipe.

1. An apparatus for the measurement of the bulk density of a fluid within a vessel comprising a source of radiation located outside the vessel, collimation means to direct the radiation through at least a portion of the vessel, a detector for detecting the radiation, said detector being located outside the vessel and arranged with respect to the radiation source such that it is capable of detecting radiation from said source after it has passed through a portion of the vessel, and at least one dip tube, said dip tube being generally cylindrical and having a dome-shaped closed end, and being arranged to penetrate the wall of the vessel such that the closed end faces the interior of the vessel and being aligned with said radiation source in such a way that radiation from the source may enter the vessel through the closed end of the dip tube.

2. An apparatus according to claim 1, wherein the energy of the source radiation is in the range from 20 keV to 750 keV.

3. An apparatus according to claim 1, wherein the source is selected from ¹³⁷Cs, ¹³³Ba, ²¹⁰Pb and ²⁴¹Am.

4. An apparatus according to claim 3, wherein the source comprises ²⁴¹Am.

5. An apparatus according to claim 1, comprising a first dip tube aligned with said radiation source in such a way that radiation from the source may enter the vessel through the first dip tube and a second dip tube which is aligned with the detector in such a way that radiation from the source may pass through a portion of the vessel and out of the vessel to the detector through the second dip tube.

6. An apparatus according to claim 5, wherein the longitudinal axes of said first and second dip tubes are aligned along a linear path extending from the source to the detector.

7. An apparatus according to claim 1, wherein the or each dip tube does not extend beyond the interior wall of the vessel into the vessel by more than 10 mm.

8. An apparatus as according to claim 1, wherein the or each dip tube is fabricated from titanium or a titanium-containing alloy.

9. An apparatus according to claim 1, wherein the detector is associated with a control system.

10. An apparatus according to claim 9, wherein said vessel is a pipeline and said control system is adapted to control fluid flow apparatus installed upstream of said detector and capable of adjusting one or more properties of the flow of fluid within said pipeline.

11. A method of measuring the bulk density of a fluid within a vessel comprising directing radiation from a radiation source through a portion of a vessel containing the fluid towards a radiation detector and calculating the bulk density of the fluid or a change in the bulk density of the fluid using information about the amount of radiation detected by the detector, characterised in that the radiation source and radiation detector are each located outside the vessel and that the radiation is directed into the vessel via at least one dip tube, being generally cylindrical and having a dome-shaped closed end, said dip tube penetrating the wall of the vessel, being arranged such that the domed end faces the interior of the vessel and being aligned with said radiation source in such a way that radiation from the source may enter the vessel through the closed end of the dip tube.

12. A method according to claim 11 wherein the fluid comprises a stream of natural gas and the vessel comprises a pipeline within which said natural gas may flow and wherein the detector is associated with a control system which is capable of effecting a change in the bulk density of the natural gas stream.

13. A method according to claim 11 using an apparatus for the measurement of the bulk density of a fluid within a vessel comprising a source of radiation located outside the vessel, collimation means to direct the radiation through at least a portion of the vessel, a detector for detecting the radiation, said detector being located outside the vessel and arranged with respect to the radiation source such that it is capable of detecting radiation from said source after it has passed through a portion of the vessel, and at least one dip tube, said dip tube being generally cylindrical and having a dome-shaped closed end, and being arranged to penetrate the wall of the vessel such that the closed end faces the interior of the vessel and being aligned with said radiation source in such a way that radiation from the source may enter the vessel through the closed end of the dip tube.
